(19) United States
(12) Patent Application Publication
(10) Pub. No.: US 2024/0358187 A1
(43) Pub. Date: Oct. 31, 2024

(54) SPLIT BOTTLE WARMER

(71) Applicant: Shenzhen DeOne Innovation Technology Co., Ltd, Shenzhen (CN)

(72) Inventor: Jiongjun Cai, Shenzhen (CN)

(21) Appl. No.: 18/474,044

(22) Filed: Sep. 25, 2023

(30) Foreign Application Priority Data
Apr. 28, 2023 (CN) 2023210166489

(51) Int. Cl. A47J 36/24

(52) U.S. Cl. CPC A47J 36/2433

(57) ABSTRACT

A split bottle warmer is disclosed, which relates to the technical field of maternal and infant supplies. The bottle warmer includes a base and a heating module detachably arranged on the base for connecting to a bottle mouth, the heating module is configured with a heating element. The base is configured with electro-contact parts, the heating module is configured with conductive parts plugged into the electro-contact parts, the heating module is configured to be electrically connected to the base when the electro-contact parts are plugged into the conductive parts, and a positioning structure is configured between the conductive parts and the electro-contact parts. By setting the conductive parts and the electro-contact parts, the split bottle warmer can realize circuit conduction and thereby having advantages of removable the heating module and the base.

### TECHNICAL FIELD

The present application relate to the technical field of maternal and infant supplies, and specifically to a novelty split bottle warmer.

### BACKGROUND

Functions of a bottle warmer are mainly used to warm and heat liquid media such as milk, milk liquid brewed by milk powder, so that it meets temperatures of infant drinking. In existing technologies, the bottle warmer is generally warmed in a water bath heating, the liquid media are placed in a bottle and then heated them in water, due to indirect heat transfer, heat conduction is slow, heating time is longer, thus user experience is not good. Another commercially available bottle warmer, its bottle mouth inverted assembled on a heating module, which may be directly heated the liquid media, but such bottle warmer is often the heated module and a base of an integrated set, resulting in the heating is completed after removal of the bottle is more troublesome.

### SUMMARY

To address the defects and deficiencies of the existing technologies, the present disclosure provides a novelty split bottle warmer, which can realize a circuit conduction of the bottle warmer by setting conductive parts and electro-contact parts, and thus can realize advantages that the heating module and the base are removable.

Specifically, the present disclosure adopts following technical solutions to achieve above objectives. In some embodiments of the present disclosure, a split bottle warmer is provided, including a base and a heating module detachably arranged on the base for connecting to a bottle mouth, the heating module is configured with a heating element. The base is configured with electro-contact parts, the heating module is configured with conductive parts plugged into the electro-contact parts, the heating module is configured to be electrically connected to the base when the electro-contact parts are plugged into the conductive parts, and a positioning structure is configured between the conductive parts and the electro-contact parts. The heating module is further configured with functional elements, a plurality of plugs and sockets plugged into each other are configured correspondingly between the heating module and the base.

In some preferred embodiments of the present disclosure, the positioning structure includes a positioning seat arranged on the base and a positioning cavity detachably assembled with the positioning seat.

In some preferred embodiments of the present disclosure, the functional elements include a temperature sensing element and a water level sensing element, and the electro-contact parts include a heating element socket, a temperature sensing element contact and a water level sensing element contact arranged on the positioning seat. The conductive parts include a heating element contact, a temperature sensing element socket and a water level sensing element socket arranged on the positioning cavity.

In some preferred embodiments of the present disclosure, the positioning seat has a cross-section of a notched circle, and the positioning cavity is shaped to fit the positioning seat.

In some preferred embodiments of the present disclosure, a control circuit board is configured within the base, the water level sensing element, the temperature sensing element and the heating element are configured to be electrically connected to the control circuit board when the electro-contact parts are plugged with the conductive parts.

In some preferred embodiments of the present disclosure, the base is further configured with a switch electrically connected to the control circuit board and a temperature adjust button.

In some preferred embodiments of the present disclosure, the base is further configured with a display electrically connected to the control circuit board, the temperature sensing element is configured to monitor in real time temperature information of a liquid medium within the bottle mouth and send the temperature information to the control circuit board, and the control circuit board is used to present the temperature information to the display.

In some preferred embodiments of the present disclosure, the display is arranged on the temperature adjust button.

In some preferred embodiments of the present disclosure, the heating module is further configured with an adapter attached thereto at one end, the adapter is connected to the bottle mouth at the other end, and the adapter is hollow.

In some preferred embodiments of the present disclosure, the adapter is configured with a second sealing element in an inner wall, the second sealing element is abutted against the bottle mouth at one end and against the heating module at the other end.

With adoption of the above technical solutions, the present disclosure has at least following advantages. The heating module is detachably assembled with the base, and the positioning structure is provided between the two, the positioning structure includes the positioning cavity arranged on the heating module and the positioning seat arranged on the base, and the positioning seat is preferably positioned centrally at bottom of an accommodation space, so that the heating module can be accurately placed on the base. The electro-contact parts include the heating element socket, the temperature sensing element contact and the water level sensing element contact arranged on the positioning seat. The conductive parts include the heating element contact, the temperature sensing element socket and the water level sensing element socket arranged on the positioning cavity. By such designs, it is thus can achieve circuit conduction of the bottle warmer by setting the conductive parts and the electro-contact parts, thereby realizing the heating module and the base can be detached without affecting a normal use.

### BRIEF DESCRIPTION OF THE DRAWINGS

In order to more clearly illustrate the technical solutions in the embodiments of the present disclosure or the existing technologies, accompanying drawings to be used in the description of the embodiments or the existing technologies will be briefly introduced below. It will be obvious that the accompanying drawings in the following description are only some of the embodiments of the present disclosure, and that for a person of ordinary skill in the art, other drawings can be obtained based on the accompanying drawings without paying creative labor.

FIG. 1 is a structural schematic diagram of a split bottle warmer in accordance with some embodiments of the present disclosure.

FIG. 2 is a separation schematic diagram of a base and a heating module in accordance with some embodiments of the present disclosure.

FIG. 3 is a disassembly schematic diagram of a partial structure of the split bottle warmer in accordance with some embodiments of the present disclosure.

FIG. 4 is a structural schematic diagram of the heating module in accordance with some embodiments of the present disclosure.

FIG. 5 is an exploded schematic diagram corresponding to FIG. 4.

FIG. 6 is a structural schematic diagram of a heat conductive element in accordance with some embodiments of the present disclosure.

FIG. 7 is a disassembly schematic diagram of another partial structure of the split bottle warmer in accordance with some embodiments of the present disclosure.

In the drawings, the reference signs are as follows.

1. base, 11. switch, 12. temperature adjust button, 13. power interface, 14. accommodation space, 15. heating element socket, 16. temperature sensing element contact, 17. water level sensing element contact, 18. positioning seat.

2. heating module, 21. placeholder, 211. mounting chamber, 22. positioning seat, 23. heating element contact, 24. temperature sensing element socket, 25. water level sensing element socket, 26. heat conductive element, 261. bulge loop, 27. first sealing element, 271. groove, 28. water level sensor, 29. heating sheet.

3. adapter, 31. snap ring.

4. second sealing element, 41. load-bearing part, 42. sealing part, 5. bottle.

### DETAILED DESCRIPTION OF THE EMBODIMENTS

The present disclosure will be further described in detail below in conjunction with the accompanying drawings.

All specific embodiments are only an explanation of the present disclosure, which is not a limitation of the present disclosure, the person of ordinary skill in the art after reading this specification can make modifications to the embodiments as needed without creative contribution, but as long as within the scope of the claims of the present disclosure are protected by the patent law.

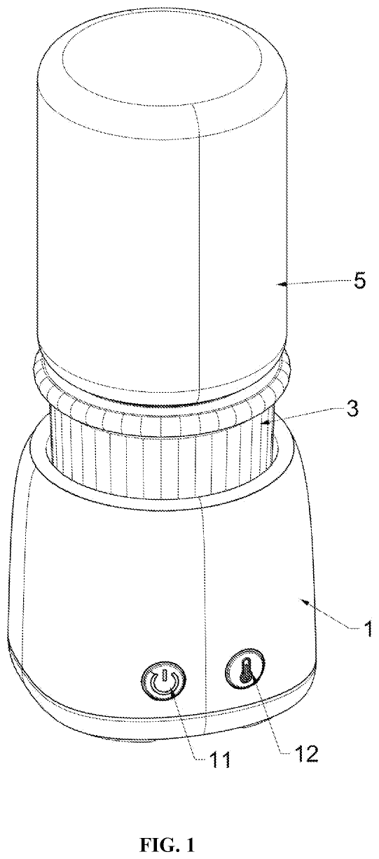

In some embodiments of the present disclosure, a split bottle warmer is provided. Referring to FIG. 1, the bottle warmer includes a base 1, and a control circuit board is arranged within the base 1. The base 1 is configured with a switch 11 and a temperature adjust button 12, the switch 11 is used to control on and off of the bottle warmer, and the temperature adjust button 12 is used to adjust heating temperatures of a heating module 2. The base 1 is further configured with a power interface 13 used for external power access, or for charging a rechargeable battery provided in the bottle warmer. The power interface 13 is preferably a type-C interface. In some other examples, the power interface 13 may be a USB interface or a micro-USB interface.

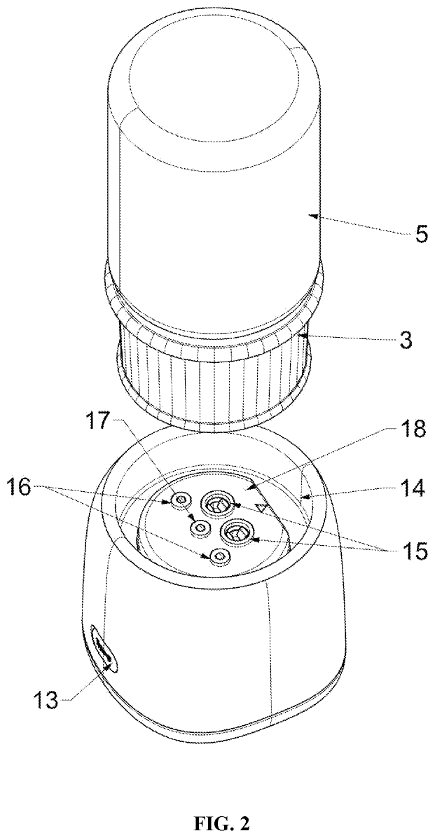

Referring to FIG. 2, the heating module 2 is provided at a top of the base 1, the base 1 is configured with an accommodation space 14 for the heating module 2 to be placed into, and the accommodation space 14 has a size to fit with the heating module 2. A placeholder 21 is arranged at bottom of the heating module 2, the placeholder 21 is configured with conductive parts, and electro-contact parts electrically connected to the conductive parts are arranged on the accommodation space 14 of the base 1. By setting contact conduction of the conductive parts and the electro-contact parts, which can realize electrical connection between the heating module 2 and the base 1, and meanwhile the switch 11 and the temperature adjust button 12 can also control the heating module 2. In the embodiments, the heating module 2 can realize heating liquid medium inside the bottle through a heating sheet 29. Moreover, the heating module 2 is further configured with at least one functional element, the functional element is, for example, a temperature sensing element and/or a water level sensing element, but not limited to above elements, and also may be a speaker or a light-emitting element.

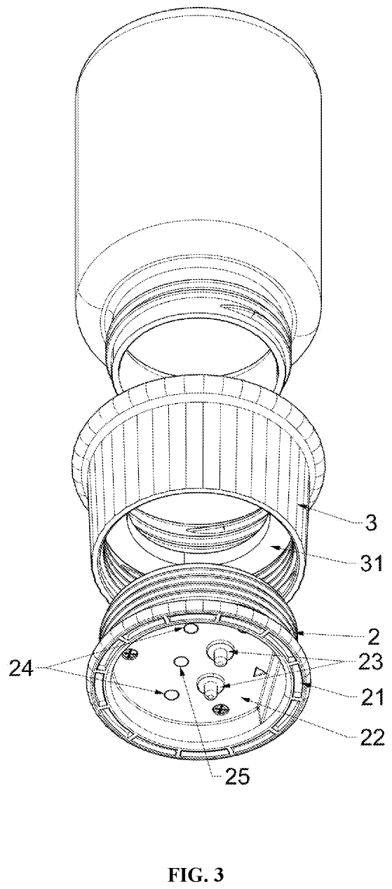

Referring to FIG. 2 and FIG. 3, the heating module 2 is detachably assembled with the base 1, a positioning structure is provided between the heating module 2 and the base 1. The positioning structure includes a positioning cavity 22 arranged on the heating module 2 and a positioning seat 18 arranged on the base 1, the positioning seat 18 is preferably arranged centrally at bottom of the accommodation space 14. The electro-contact parts include two heating element sockets 15, two temperature sensing element contacts 16 and a water level sensing element contact 17 arranged on the positioning seat 18. The conductive parts include two heating element socket 23, two temperature sensing element socket 24 and a water level sensing element socket 25 arranged on the positioning cavity 22.

In the embodiments of the present disclosure, the positioning seat 18 has a cross-section of a notched circle, and the positioning cavity 22 is shaped to fit the positioning seat 18. By such designs, the positioning seat 18 can prevent the heating module 2 or the base 1 from rotating along its own axis when the heating module 2 is placed onto the base 1, causing the electro-contact parts to be misaligned with the conductive parts, and thus can keep the electro-contact parts and the conductive parts electrically connected.

In some other embodiments of the present disclosure, the positioning structure includes a guiding groove provided on a side wall of the accommodation space 14 and a guiding block provided on a side wall of the heating module 2. Alternatively, the positioning structure includes a first magnetic member provided inside the accommodation space 14 and a second magnetic member provided on the heating module 2, a positioning can be realized by magnetic cooperation between the first magnetic member and the second magnetic member.

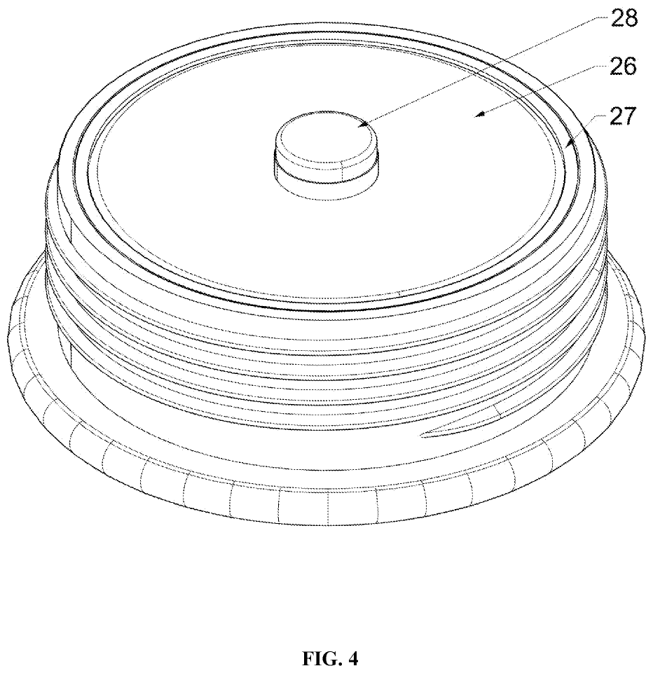

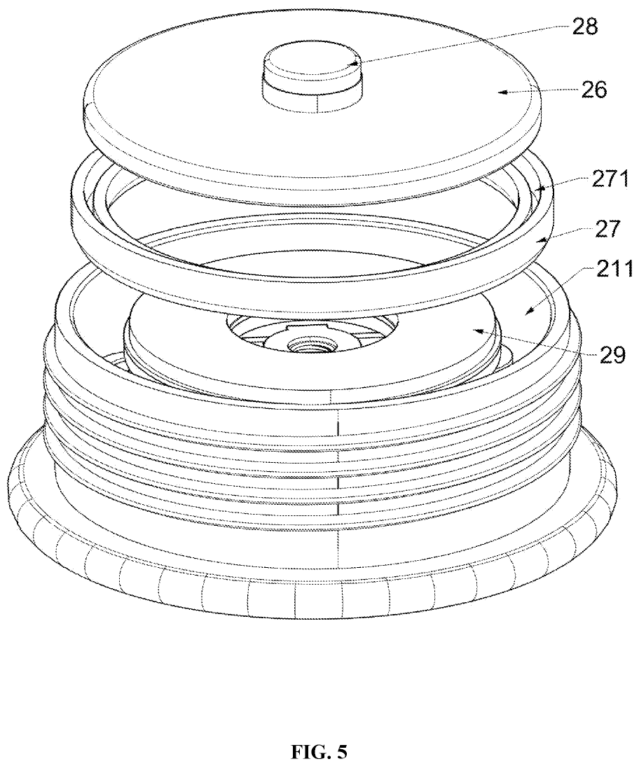

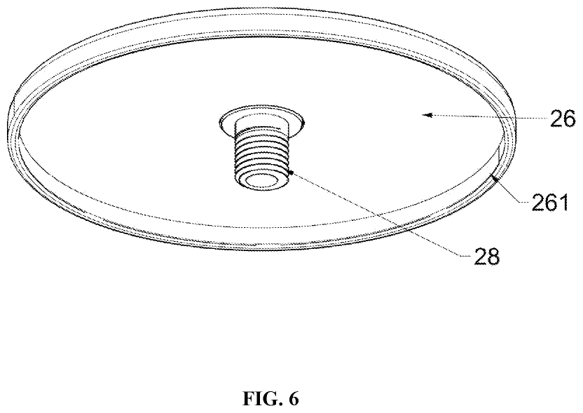

Referring to FIG. 2, FIG. 4, FIG. 5 and FIG. 6, the heating module 2 is configured with a mounting chamber 211 at top, a heating element is provided within the mounting chamber 211, and a heat conductive element 26 is provided on a covering cap of the mounting chamber 211. The heat conductive element 26 may conduct heat emitted by the heating element to liquid medium in the bottle above the heat conductive element, thus can realize heating of the liquid medium.

In some preferred embodiments of the present disclosure, a water level sensing element is also provided on a side of the heat conductive element 26 near the adapter 3, the water level sensing element is a water level sensor 28, the water level sensor 28 can remind a user when water level is too low to prevent dry burning damage to the device, and its reminder can be a voice reminder or a light reminder. The heat conductive element 26 is configured with a temperature sensing element near one end thereof, the temperature sensing element is a water temperature sensor that can detect temperatures of the liquid medium inside the bottle 5 in real time and send the temperature data to a control circuit board, and the control circuit board can provide temperature data on a display for the user to know current temperature information. The display may be arranged on the temperature adjust button 12, or may be arranged on other positions of the base 1.

It should be added that, a first sealing element 27 is configured between the heat conductive element 26 and an opening inner wall of the mounting chamber 211, so that the first sealing element 27 is sandwiched between the heating conductive element 26 and the opening inner wall of the mounting chamber 211, which can effectively prevent the liquid medium from entering the heating module 2 through a gap between the heat conductive element 26 and the mounting chamber 211.

In some preferred embodiments of the present disclosure, the first sealing element 27 is configured with a groove 271 that causes the entire first sealing element 27 to be divided into two parts, one part of which is clamped by the heat conductive element 26 and the mounting chamber 211, and a bottom edge of the heat conductive member 26 is provided with a bulge loop 261 embedded in the groove 271. The other part of the first sealing element 27 can cooperate with this design to enclose inner and outer sides of the bulge loop 261, so as to improve water repellency of the whole sealing structure. The first sealing element 27 is designed in a form of ring with a U-shaped cross section, and the heat conduction element 26 is designed in a form of a circle with a r-shaped cross-section. In a preferred example, the first sealing element 27 is made of silicone. In other example, the first sealing element 27 is made of rubber.

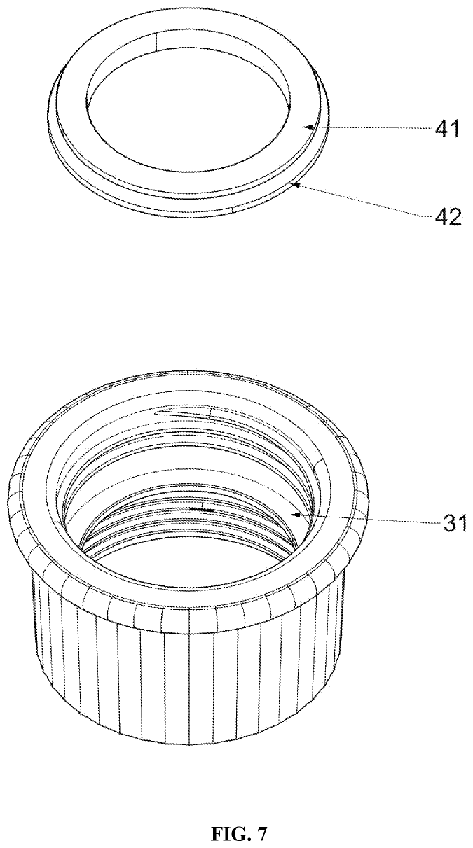

Referring to FIG. 4 to FIG. 7, a second sealing element 4 includes a load-bearing part 41 arranged on a side near the bottle mouth, the load-bearing 41 is abutted against the mottle mouth, so as to provide a cushioning effect after the bottle 5 is connected to the adapter 3 and improve the stability of the bottle 5 after being connected to the adapter 3. The second sealing element 4 is configured with a sealing part 42 near the side of the heat conductive element 26, and the sealing part 42 is capped on the first sealing element 27 to prevent the liquid medium flowing out of the bottle 5 when it is inverted from flowing to the first sealing element 27, thus can improve the sealing of the heating module 2. The sealing part 42 and the load-bearing part 41 are configured as rings, and the sealing part 42 has a smaller inner diameter than the out diameter of the heat conductive element 26, which can effectively avoid the liquid medium from entering the first sealing element 27 through the sealing part 42. In a preferred example, the second sealing element 4 is made of silicone. In other example, the second sealing element 4 is made of rubber.

It should be added that, a mounting groove is provided between the sealing part 42 and the load-bear part 41, and a snap ring 31 is correspondingly provided on the inner wall of the adapter 3 for the mounting groove to snap into and be positioned. When the second sealing element 41 is mounted on the snap ring 31 through the mounting groove, the second sealing element 4 will be positioned on the inner wall of the adapter 3.

Referring to FIG. 3, the adapter 3 includes a hollow tube, a snap ring 31 is set in the inner wall of the tube, and the tube is divided into upper and lower parts by the snap ring 31. The upper part is provided with first internal threads for the bottle mouth threaded connection on it, the lower part is second internal threads, external threads is provided on the outer wall of the heating module 2 to be fitted with the second internal threads, so that the adapter 3 can be disassembled and assembled with the heating module 2, thus can facilitate cleaning of the heating module 2 and the adapter 3.

It should be added that, there may be a plurality of the adapter 3, all of which have different diameters, the first internal threads provided thereon are changed accordingly, thereby can adapt to a plurality of bottle with variety diameters and improve adaptability of the bottle warmer of the present disclosure.

The above description is only used to illustrate the technical solutions of the present disclosure but not to limit, other modifications or equivalent substitutions made to the technical solutions by the person of ordinary skill in the art should be covered by scope of the claims of the present disclosure only if they do not deviate from the spirit and the scope of the technical solutions of the present disclosure.

What is claimed is:

1. A split bottle warmer, comprising
a base and
a heating module detachably arranged on the base for connecting to a bottle mouth, and the heating module is configured with a heating element;
wherein the base is configured with electro-contact parts, the heating module is configured with conductive parts plugged into the electro-contact parts, the heating module is configured to be electrically connected to the base in response to the electro-contact parts being plugged into the conductive parts, and a positioning structure is configured between the conductive parts and the electro-contact parts; and
the heating module is further configured with functional elements, a plurality of plugs and sockets plugged into each other are configured correspondingly between the heating module and the base.

2. The split bottle warmer according to claim 1, wherein the positioning structure comprises a positioning seat arranged on the base and a positioning cavity detachably assembled with the positioning seat.

3. The split bottle warmer according to claim 2, wherein the functional elements comprise a temperature sensing element and a water level sensing element, and the electro-contact parts comprise a heating element socket, a temperature sensing element contact and a water level sensing element contact arranged on the positioning seat; and
the conductive parts comprise a heating element contact, a temperature sensing element socket and a water level sensing element socket arranged on the positioning cavity.

4. The split bottle warmer according to claim 2, wherein the positioning seat has a cross-section of a notched circle, and the positioning cavity is shaped to fit the positioning seat.

5. The split bottle warmer according to claim 1, wherein a control circuit board is configured within the base, the water level sensing element, the temperature sensing element and the heating element are configured to be electrically connected to the control circuit board in response to the electro-contact parts being plugged with the conductive parts.

6. The split bottle warmer according to claim 5, wherein the base is further configured with a switch electrically connected to the control circuit board and a temperature adjust button.

7. The split bottle warmer according to claim 6, wherein the base is further configured with a display electrically connected to the control circuit board, the temperature sensing element is configured to monitor in real time temperature information of a liquid medium within the bottle mouth and send the temperature information to the control circuit board, and the control circuit board is used to present the temperature information to the display.

8. The split bottle warmer according to claim 7, wherein the display is arranged on the temperature adjust button.

9. The split bottle warmer according to claim 1, wherein the heating module is further configured with an adapter attached thereto at one end, the adapter is connected to the bottle mouth at the other end, and the adapter is hollow.

10. The split bottle warmer according to claim 9, wherein the adapter is configured with a second sealing element in an inner wall, the second sealing element is abutted against the bottle mouth at one end and against the heating module at the other end.
